(19) United States
(12) Patent Application Publication
(10) Pub. No.: US 2026/0238982 A1
(43) Pub. Date: Aug. 13, 2026

(54) DIFFERENTIATED MAPS FOR ZERO-SCAN ROAMING

(71) Applicant: Cisco Technology, Inc., San Jose, CA (US)

(72) Inventors: Jerome Henry, Pittsboro, NC (US); Matthew S. MacPherson, Apex, NC (US); Sudhir K. Jain, Fremont, CA (US)

(73) Assignee: Cisco Technology, Inc., San Jose, CA (US)

(21) Appl. No.: 19/535,683

(22) Filed: Feb. 10, 2026

Related U.S. Application Data
(60) Provisional application No. 63/756,651, filed on Feb. 10, 2025.

(51) Int. Cl. H04W 8/08; H04W 36/32

(52) U.S. Cl. CPC H04W 8/08; H04W 36/322

(57) ABSTRACT

Generating and using differentiated maps for roaming may be provided. One or more access points (APs) collect roaming information associated with a plurality of stations (STAs) in a wireless network. Differentiated roaming maps are generated based on the roaming information, wherein each differentiated roaming map of the plurality of differentiated roaming maps corresponds to a respective type and indicates roaming patterns for STAs associated with that respective type. A first AP receives a roaming recommendation request from a first STA and determines a roaming recommendation indicating a second AP for the first STA to roam to based on a first differentiated roaming map from the plurality of differentiated roaming maps corresponding to a type of the first STA The first AP then provides the roaming recommendation to the first STA.

### RELATED APPLICATION

Under provisions of 35 U.S.C. § 119(e), Applicant claims the benefit of and priority to U.S. Provisional Application No. 63/756,651, filed February 10, 2025, the disclosure of which is incorporated herein by reference in its entirety.

### TECHNICAL FIELD

The present disclosure relates generally to generating and using differentiated maps for roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for roaming using differentiated maps in accordance with aspects of the present disclosure.

FIG. 2 illustrates an example vector map with movement paths of a first type of device in accordance with aspects of the present disclosure.

FIG. 3 illustrates the example vector map with movement paths of a second type of device in accordance with aspects of the present disclosure.

FIG. 4 is an example user interface with roaming recommendations in accordance with aspects of the present disclosure.

FIG. 5 is a flow diagram illustrating a method for roaming using differentiated maps in accordance with aspects of the present disclosure.

FIG. 6 is a block diagram of a computing device in accordance with aspects of the present disclosure.

FIG. 7 is a block diagram of a communications device in accordance with aspects of the present disclosure.

### DETAILED DESCRIPTION

### OVERVIEW

Generating and using differentiated maps for roaming may be provided. One or more access points (APs) collect roaming information associated with a plurality of stations (STAs) in a wireless network. Differentiated roaming maps are generated based on the roaming information, wherein each differentiated roaming map of the plurality of differentiated roaming maps corresponds to a respective type and indicates roaming patterns for STAs associated with that respective type. A first AP receives a roaming recommendation request from a first STA and determines a roaming recommendation indicating a second AP for the first STA to roam to based on a first differentiated roaming map from the plurality of differentiated roaming maps corresponding to a type of the first STA The first AP then provides the roaming recommendation to the first STA.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless networks enable users to maintain connectivity while moving through different coverage areas. In traditional roaming methods, a wireless device, referred to as a Station (STA), scans available channels when transitioning between network devices, referred to as Access Points (APs), to identify the best available AP for connection. The STA typically scans across one or more entire radio bands to identify available APs. This scanning process, however, introduces latency, consumes client power, increases channel congestion, and can disrupt connectivity. Therefore, scanning can result in interruptions that degrade the user experience, particularly for latency-sensitive applications such as voice over Wi-Fi or real-time streaming.

To address these challenges, various methods have been developed to enable seamless roaming across Wi-Fi networks. Zero-scan roaming is in development to enable a STA to transition between APs within a wireless network without performing an active or passive channel scan. By bypassing or reducing the scanning phase of roaming, zero-scan roaming reduces handoff latency, minimizes packet loss, conserves client power, and improves the overall user experience.

Existing roaming methods can involve mechanisms that assist the STA in making informed roaming decisions without requiring extensive scanning operations. For example, the Institute of Electrical and Electronics Engineers (IEEE) 802.11k amendment describes a process to create and share a neighbor report containing information about known neighbor APs that are candidates for a service set transition. A STA can utilize the neighbor report to identify available APs without performing a full scan and can avoid connecting to an overutilized or otherwise congested AP simply because that AP has the strongest signal at the time the STA determines to roam. When certain transition conditions are met (e.g., signal degradation, load balancing triggers, or motion detection), the STA can determine to roam to an AP included in the received neighbor report without performing a scan operation, or may perform scanning only for one or more of the APs included in the neighbor report.

Similarly, the IEEE 802.11v amendment defines Basic Service Set (BSS) Transition Management (BTM), which enables an STA to send a BTM query requesting information about the next optimal AP from the AP to which the STA is currently connected. The AP may then recommend an optimal neighboring AP for roaming. For example, when a STA approaches the edge of a coverage area (e.g., a cell or a Basic Service Area (BSA)) serviced by an AP, the AP may suggest a neighboring AP to which the STA can roam.

Despite the advantages of these roaming methods, current implementations face several limitations. Neighbor reports may be limited to the “loudest” (i.e., highest detected signal strength) neighbors around the current AP from the current AP’s viewpoint. While the neighbor report enables a STA to limit scanning to a subset of channels (e.g., channels of the APs in the list), the list of channels to scan may still be long and may lack prioritization. Additionally, the STA may not be able to detect each AP in the neighbor report list. For example, a STA moving in one direction may detect only a subset of the APs in the list in that direction, while a STA moving in another direction may detect a different subset of APs. Furthermore, the STA may be moving away from a recommended neighboring AP, making the recommended AP an unsuitable choice for roaming. Response times for BTM queries can also be significant, sometimes up to 400 milliseconds, leading to delays and interruptions in connectivity. The STA may also need to reach the edge of the cell serviced by the AP before detecting the next optimal AP, which can result in delays and interrupt seamless connectivity. As a result, roaming continues to face challenges in meeting user expectations for seamless and uninterrupted connectivity.

Moreover, current roaming approaches focus primarily on detecting STA movement and direction to provide recommendations on the next best AP to roam to. However, there are many scenarios where the optimal roaming recommendation may depend on the specific STA, with different STAs requiring different recommendations based on their type, role, or usage patterns. For example, in a shopping mall environment, devices associated with employees may traverse different paths than devices associated with guests, traversing shortcuts and back corridors that guests do not access. Employee devices may also roam at different times, such as during night shifts for inventory tasks, when guest devices are not present. Current roaming methods do not differentiate between these STA types and cannot provide customized recommendations that account for such differences.

Optimal roaming recommendations may depend on environmental constraints, such as the presence and density of other STAs in the area. In high-density scenarios, such as large conferences where crowds of people move along the same path, providing identical roaming recommendations to all STAs can cause overload on a single AP. Current methods lack mechanisms to dynamically adjust recommendations based on real-time environmental factors and load balancing considerations.

Disclosed herein are systems, methods, and computer-readable media for enabling or otherwise improving zero-scan roaming that generates differentiated roaming maps depending on STA type and environmental factors. The disclosed techniques enable APs or an associated mapping system to record the history of STA requests, AP responses, and roaming events, along with additional information related to STA movement, such as dwell time, traversal time, and distances between roaming events. This information is used to build differentiated roaming maps, including vector maps between APs that indicate directional information, traversal times, and distances between BSSs. The system can maintain separate maps for different STA types (e.g., employee maps versus guest maps) and can provide roaming recommendations that match the STA type and current environmental conditions. The disclosed techniques may also include enhanced roaming recommendations that incorporate temporal or distance elements, such as “roam to AP2 in 18 meters” or “roam to AP2 in about 10 seconds,” enabling STAs to better anticipate roaming events. Additionally, APs or other network devices may track recent roaming recommendations and decisions, enabling dynamic load balancing that distributes STAs across multiple candidate APs based on current density and past recommendations. These improvements enable more accurate, efficient, and seamless roaming experiences tailored to specific STA types and real-time network conditions.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

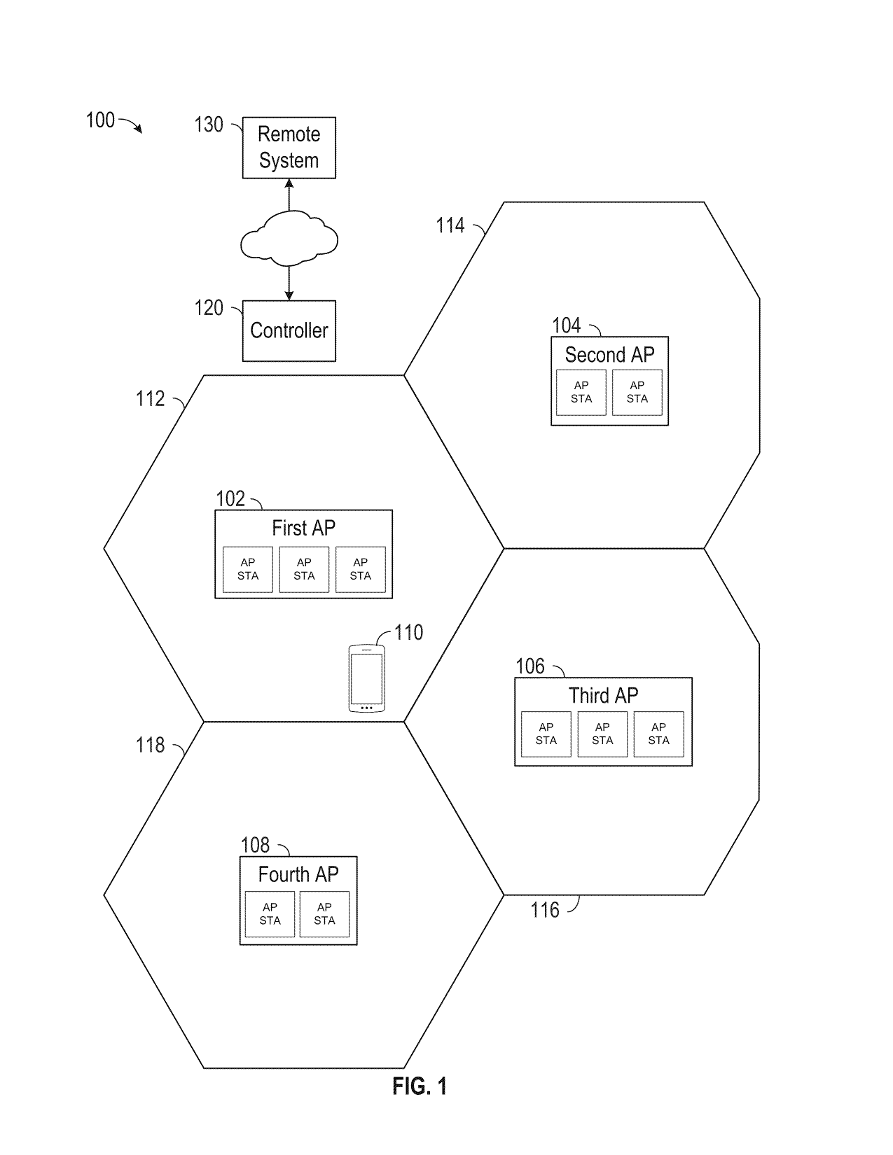

FIG. 1 is a block diagram of an operating environment 100 for roaming using differentiated maps. In the illustrated embodiment, the operating environment 100 includes a first AP 102, a second AP 104, a third AP 106, a fourth AP 108, a STA 110, a controller 120, and one or more remote systems 130. The first AP 102 has a service area or cell indicated by the first cell 112. Similarly, the second AP 104 has the second cell 114, the third AP 106 has the third cell 116, and the fourth AP 108 has the fourth cell 118. The range of the first AP 102, the second AP 104, the third AP 106, and the fourth AP 108 can extend past the boundary of the associated cells, with the signals of the APs growing weaker past the boundaries of the respective cells. Thus, the first AP 102, the second AP 104, the third AP 106, and the fourth AP 108 may fail to communicate with devices some distance past the edges of the associated cells. With overlapping service areas, the APs enable seamless roaming operations, such as zero-scan roaming. The arrangement of APs and cells and the edges of the first cell 112, the second cell 114, the third cell 116, and the fourth cell 118 as shown in the operating environment 100 are an example and may be different in other examples (e.g., different sizes, shapes, etc.).

The STA 110 is any device that connects to the network to communicate with other devices on the network, such as a smart phone, a tablet, a personal computer, a server, and the like. In some embodiments, the STA 110 may be associated with a STA type that indicates characteristics about the STA 110, its user, or its usage patterns. For example, the STA type may distinguish between employee devices and guest devices, with employee devices accessing different network areas or following different movement patterns than guest devices. In a shopping mall environment, employees may traverse different paths than guests, using shortcuts and back corridors that guests do not access, and employees may roam at different times, such as during night shifts for inventory tasks when guests are not present. The STA type may be determined based on authentication credentials, network access policies, device profiles, time of day, or other identifying information.

The controller 120 is any network controller (e.g., a Wireless Local Area Network (WLAN) controller) and provisions, controls, and otherwise manages the first AP 102, the second AP 104, the third AP 106, the fourth AP 108, and other network devices to allow wireless devices such as the STA 110 to connect to the network. In some embodiments, the operations of the controller 120 described herein may be performed by one or more of the first AP 102, the second AP 104, the third AP 106, the fourth AP 108, and/or another device, and vice versa. The operating environment 100 is an example configuration and there may be a different number of STAs, APs, controllers, and/or other devices in further examples.

The remote system 130 is a remote service or application that, in certain embodiments, performs operations for generating differentiated maps and providing roaming recommendations. Various combinations of the remote system 130, the controller 120, and/or the APs can perform the map generation and recommendation operations in various embodiments, enabling APs to directly handle roaming recommendations or to delegate the operations to other devices. Delegating operations may be advantageous to utilize information from multiple APs, to offload processing requirements from APs to other devices with greater computational resources, or to enable centralized management of roaming recommendations across the network.

In some embodiments, the first AP 102, the second AP 104, the third AP 106, and/or the fourth AP 108 are Multi-Link Devices (MLDs) each including multiple AP STAs. For example, the first AP 102 is illustrated as having three AP STAs, and the second AP 104 is illustrated as having two AP STAs. However, each AP can have any number of AP STAs in further embodiments. Each AP STA may include Physical (PHY)-layer and lower-Media Access Control (MAC) components. The first AP 102, the second AP 104, the third AP 106, and the fourth AP 108 may also include an upper-MAC for coordinating the AP STAs and providing Logical Link Control (LLC).

Each AP STA may act as an AP and a single link of the respective MLD, and each AP STA of a respective AP may use a different channel. For example, the first AP 102 may include three AP STAs, with one AP STA operating on one of the channels of the 2.4 Gigahertz (GHz) band (e.g., channel one with center frequency 2.412 GHz, channel two with center frequency 2.417 GHz, channel three with center frequency 2.422 GHz, etc.), one AP STA operating on a channel of the 5 GHz band, and one AP STA operating on a channel of the 6 GHz band. The first AP 102, the second AP 104, the third AP 106, and the fourth AP 108 may be co-channel APs, with the respective AP STAs operating on one or more of the same channels. Clients, such as the STA 110, can link or connect to one or more AP STAs of the first AP 102, the second AP 104, the third AP 106, and the fourth AP 108.

The devices of the network, including the first AP 102, the second AP 104, the third AP 106, the fourth AP 108, the controller 120, and/or the remote system 130, can enable improved zero-scan roaming by generating differentiated maps and providing customized roaming recommendations based on the maps. STAs associate to APs according to standard processes and request roaming recommendations from the APs, such as through zero-scan roaming processes or existing roaming processes like 802.11v BTM queries or 802.11k neighbor requests.

The APs (or an associated mapping system such as the controller 120 or the remote system 130) record the history of the STA requests, the AP responses, and the roaming events. The APs or associated mapping system also records additional information available related to STA movement, such as the time before the next roaming event, the dwell time on the next AP, and/or the distance between these different events when this information is available (e.g., with STA location feedback, Fine Timing Measurement (FTM), or other ranging or positioning techniques). These elements are used by the APs or the associated mapping system to build one or more local roaming maps for the venue of the APs. The local roaming maps can include one more vector maps between all APs (e.g., at the scale of a floor or facility). For each AP, the map indicates elements such as the next best AP in any direction, the traversal time of the AP BSS, and/or the distance or times between BSSs.

In some embodiments, the STA type is recorded and differentiated maps are built accordingly. For example, in a shopping mall, a public roaming map is built from the roaming events of guest STAs, while a staff map is built from the roaming events of employee STAs. These maps are different because the paths used by employee STAs will likely be different from the paths traversed by guest STAs, and the time intervals where those roaming movements occur will also be different. Guest STAs are not expected at night while employee movements are expected, for example.

When an STA associates to an AP and the STA and AP establish a communication link, such as the STA 110 and the first AP 102, and subsequently requests a roaming recommendation, the AP and/or the associated mapping system uses the differentiated maps to provide a recommendation to roam to an AP based on information of the maps, the STA type, and/or the current time value. For example, the first AP 102 provides a roaming recommendation to the STA 110 to enable the STA 110 to perform zero-scan roaming.

The recommendation can vary based on STA type and time values according to characteristics associated with the STA type. For example, employee STAs arriving at night for an inventory task can be guided through employee shortcuts to the store area that is their destination, while guest STAs entering the facility during daytime do not receive roaming recommendations that match a shortcut.

Different devices may also receive different recommendations at different levels of detail. For example, guest STAs may be provided turn-by-turn recommendations based on the roaming recommendations because the path of guest STAs is well known (e.g., people do not traverse walls, the most common path is to enter at the main entrance, loop in a clockwise circle around the facility, and to exit at the main entrance). In some embodiments, the recommendation includes temporal or distance elements such as “roam to AP2 in 18 meters” or “roam to AP2 in about 10 seconds.” This additional information can be used by the STA 110 itself, equipped with measurement apparatus such as a gyroscope or clock, to anticipate the time at which the next AP should be scanned and discovered. This additional information can also be surfaced to the user.

In another embodiment, the AP (e.g., the first AP 102) maintains a counter that records different elements, including the number of STAs that requested a recommendation in the last time interval, the number and identity of the APs that were recommended to these STA, and the roaming decision that each of these STAs made. In example implementations, the counter is implemented using a sliding window. Upon receiving a new STA request (802.11v BTM, 802.11k neighbor request, or other), the AP examines these elements and uses them as weights to provide a better, targeted response to the STA.

In one embodiment, the first AP 102 load balances the recommendations based on STA density and past recommendations. For example, in a scenario where users moving along a specific vector roam to the second AP 104 in 40% of cases and to the third AP 106 in 30% of cases (both APs being valid roaming points in the same general direction), the first AP 102 can recommend the second AP 104 or the third AP 106 as the primary roaming candidate based on the number of past recommendations it made. If the first AP 102 has been recommending the second AP 104 first and then the third AP 106 and recorded that most STAs roamed to the second AP 104, then the first AP 102 may start recommending the third AP 106 alone to load balance the user traffic. In one embodiment, the AP considers its recommendations and the roaming events alone. In another embodiment, AP-to-AP communication allows the AP to measure the load on the second AP 104 and the third AP 106 and adapt its recommendations accordingly. In yet another embodiment, the roaming recommendations are connected to a Radio Resource Management (RRM) engine, causing the first AP 102 to suggest the second AP 104 to reduce its power and the third AP 106 to increase its power to load balance the roaming events from the first AP 102 to these two APs. This input is fed into the RRM engine, which uses this information as a parameter in its power balancing decisions. This mechanism avoids situations where, in high-density scenarios such as large conferences, crowds of people moving along the same path cause overload on a given AP because they are all given the same roaming recommendation.

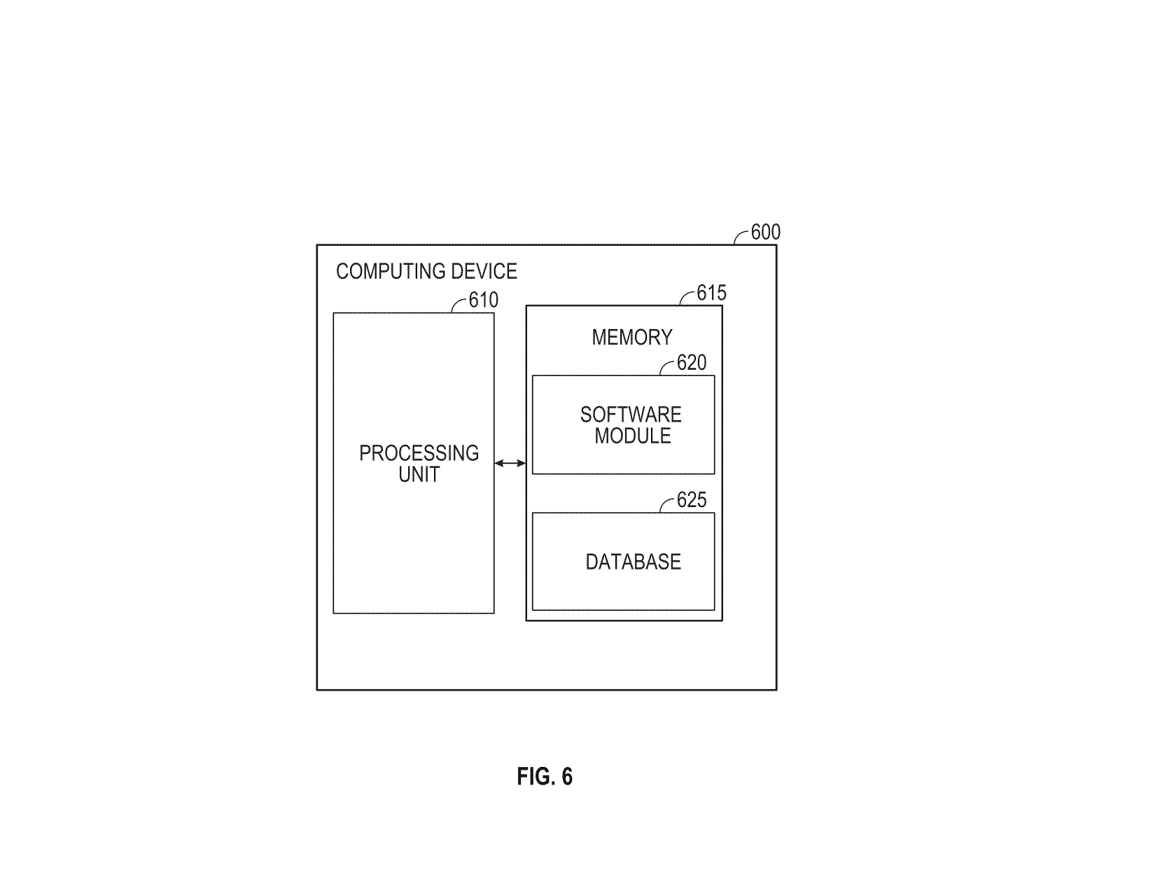

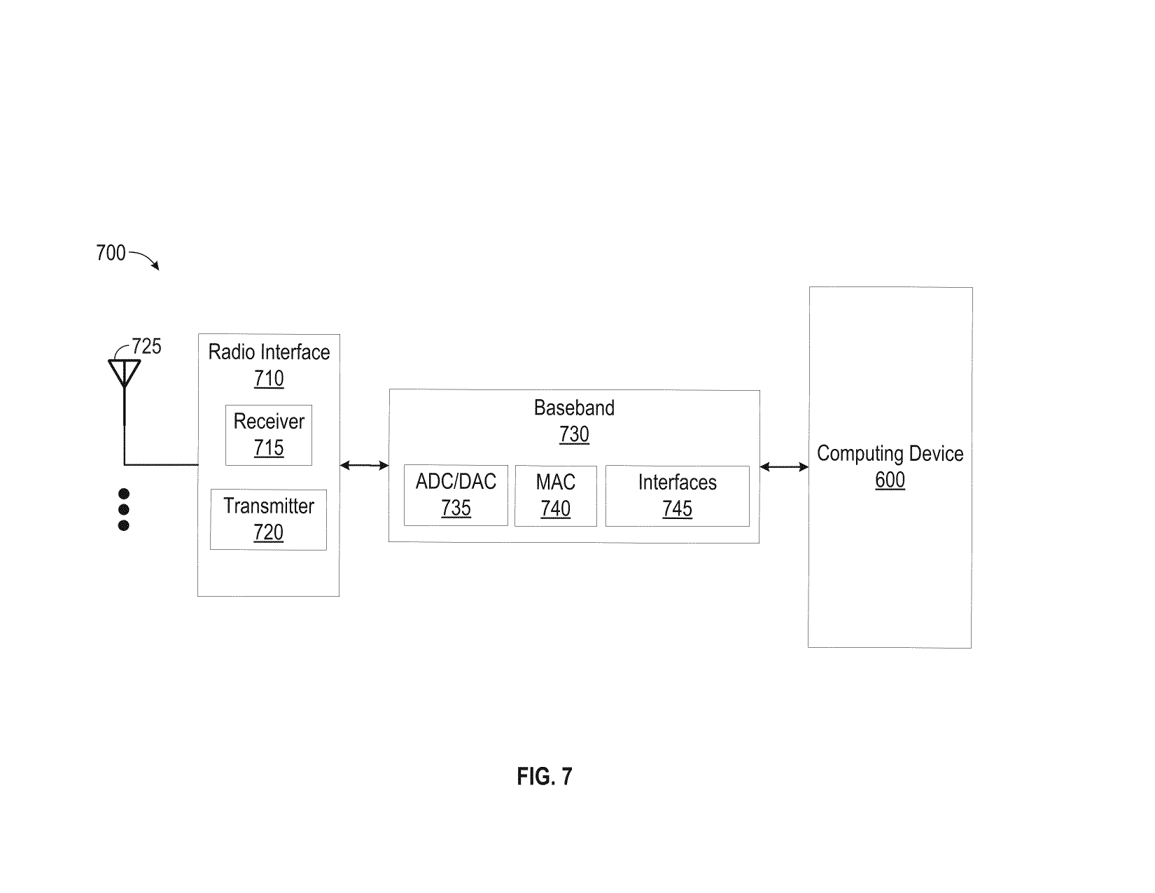

The elements described above of the operating environment 100 (e.g., the first AP 102, the second AP 104, the third AP 106, the fourth AP 108, the STA 110, the controller 120, the remote system 130, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

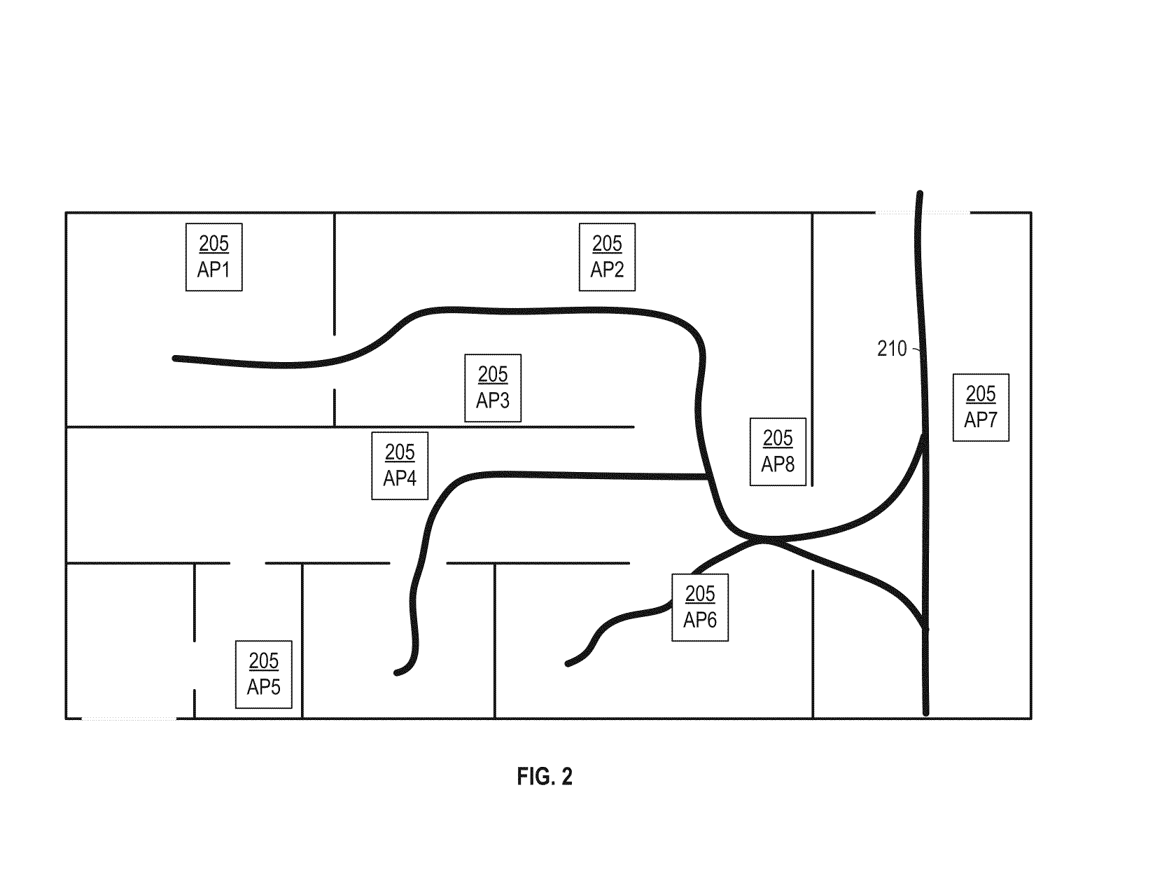

FIG. 2 illustrates an example vector map 200 with movement paths of a first type of device. The vector map 200 is a map of a venue with multiple APs 205 (AP1, AP2, AP3, AP4, AP5, AP6, AP7, and AP8). The first type of device is a guest STA in example implementations.

The APs 205 and/or an associated mapping system (e.g., the controller 120, the remote system 130) record the history of STA requests, AP responses, roaming events, and information related to the movement of STAs in the venue. For example, the APs 205 collect movement information including the time before the next roaming event, the dwell time on the next access point, and the distance between these different events. Distance information may be obtained with STA location feedback, FTM, or other ranging or positioning techniques.

The APs 205 and/or the associated mapping system use the collected information to generate a roaming map, including the vector map 200 at the scale of the venue (e.g., a building, a facility). The roaming map may include various data structures for storing and accessing roaming information, such as the vector map 200, lookup tables, databases, graphs, matrices, or other suitable data structures. The vector map 200 provides a spatial representation of the venue with AP locations and movement paths, while the underlying roaming map data structures enable efficient storage and retrieval of roaming parameters. For each AP, the roaming map indicates elements such as the next best AP in any direction, the traversal time of the AP BSS, and the distance or times between BSSs. For example, the roaming map stores that the best AP from AP7 is AP8 (or AP6 based on expected load of AP8 determined using the sliding window mechanism described with respect to FIG. 1). The roaming map can include the locations of the APs 205, their respective coverage areas, directional information indicating which APs are commonly roamed to from respective APs, traversal times and distances between APs, dwell times at each AP, signal strength characteristics, load balancing weights, and temporal patterns indicating when certain roaming paths are active.

In certain embodiments, when collecting information, the APs 205 and/or the associated mapping system identify the STA types of the STAs and build a differentiated map for each STA type or groups of STA types. For example, the vector map 200 is built based on the roaming events of STAs with a guest type (indicating the STAs are associated with guests of the venue), while a separate staff map is built from the roaming events of employee STAs. The first type expected path 210 corresponds to the common paths or otherwise expected paths traversed by guest type STAs based on historical roaming data. The maps are different because the paths used by employees will likely be different from the paths used by guests, and the time intervals when those roaming movements occur will also be different.

The first type expected path 210 can include information based on the time intervals when those roaming movements occur. For example, the paths of guest STAs may differ depending on the time of day. A particular room in the venue may be utilized consistently in the morning on weekdays, resulting in most guest STAs following a path to that room at that time. Guest STAs may not be present in the venue late at night and early in the morning, so there would be no expected path for guest STAs during this period. The first type expected path 210 can therefore vary from the illustrated paths based on the time of day, day of the week, date, or other temporal factors.

When a guest STA enters the venue from an entrance, the guest STA can initially associate to AP7, thereby establishing a connection between the guest STA and AP7. When the guest STA determines to roam or that roaming will occur soon, the guest STA requests a roaming recommendation from AP7 through zero-scan roaming processes (or existing roaming processes such as an 802.11v BTM query or 802.11k neighbor request). Based on the first type expected path 210, the time period, the expected load of the APs, and other information in the roaming map, AP7 can recommend AP8 and/or AP6 (or some other AP in further embodiments). Thus, when a STA requests a roaming recommendation, the system uses the roaming map to provide a recommendation that matches the STA type and the current time value. For example, guests entering the facility during daytime receive roaming recommendations that follow typical guest paths indicated by the first type expected path 210.

In certain embodiments, the guest STA is provided a turn-by-turn recommendation based on the roaming recommendations. For example, the turn-by-turn recommendation prompts the user of the STA to proceed from the entrance and take a right into the area with AP6 and AP8. The turn-by-turn recommendation can then further guide the user of the STA to other areas of the venue. In example implementations, the recommendation includes temporal or distance elements such as “roam to AP8 in 18 meters” or “roam to AP8 in about 10 seconds.” This additional information can be used by the STA itself, equipped with measurement apparatus such as gyroscopes or clocks, to anticipate the time at which the next AP should be scanned and discovered. This additional information can also be surfaced to the user.

In one embodiment, the APs 205 can perform load balancing when providing roaming recommendations. For example, AP1 load balances the recommendations based on STA density and past recommendations. In a scenario where a STA is moving out of the room with AP1, AP1 can recommend AP2, AP3, or AP4 as the primary roaming candidate based on the number of past recommendations it made. If AP1 has been recommending AP2 first and then AP3 or AP4 and recorded that most STAs roamed to AP2, then AP1 may start recommending AP3 or AP4 alone to load balance the user traffic. In some embodiments, the AP providing the roaming recommendation considers its recommendations and the roaming events alone. In other embodiments, AP-to-AP communication allows the AP to measure the load on AP2, AP3, and AP4 and adapt its recommendations accordingly. In yet further embodiments, the APs make roaming recommendations using an RRM engine, causing the AP to suggest one or more APs to reduce power and one or more other APs to increase power to load balance the roaming events to other APs. The roaming recommendations and/or roaming results are fed into the RRM engine, which uses this information as a parameter in its power balancing decisions.

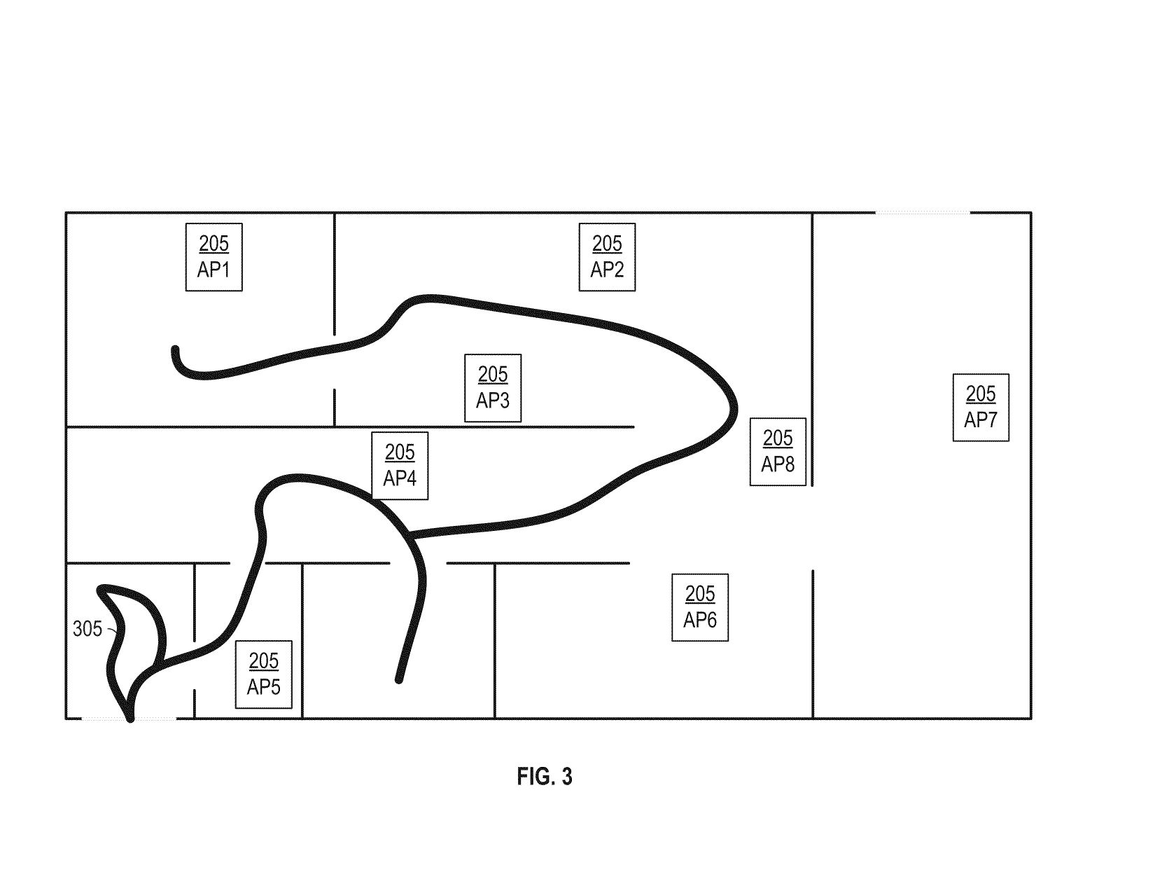

FIG. 3 illustrates an example vector map 300 with movement paths of a second type of device. The vector map 300 depicts the same venue as the vector map 200 of FIG. 2, with the same APs 205 (AP1, AP2, AP3, AP4, AP5, AP6, AP7, and AP8). However, the vector map 300 is built based on the roaming events of STAs with an employee or staff type (indicating the STAs are associated with employees of the venue), in contrast to the guest type STAs depicted in FIG. 2. The second type expected path 305 corresponds to the common paths or otherwise expected paths traversed by employee type STAs based on historical roaming data.

The vector map 300 demonstrates how differentiated maps enable customized roaming recommendations for different STA types. The paths used by employees are different from the paths used by guests because employees traverse shortcuts and back corridors that guests do not access. For example, the second type expected path 305 illustrates that employee STAs typically enter the venue through a secondary entrance (e.g., a staff entrance or back entrance) where they initially connect to AP5, whereas guest STAs depicted in FIG. 2 enter through a main entrance and initially connect to AP7. From AP5, employee STAs commonly roam to AP1, AP2, AP3, AP4, or AP8, for example, depending on their destination within the venue. The second type expected path 305 can include traversal of areas not typically accessed by guests such as storage rooms, employee break areas, or maintenance corridors, a differing frequency of travel at various points of the venue, and so on.

The time intervals when employee roaming movements occur are also different from guest movements. For example, employees may arrive at night for inventory tasks when guests are not present in the venue. The second type expected path 305 can therefore include temporal information indicating that certain paths are active during night shifts or early morning hours when the guest map would show no expected activity. Conversely, during peak guest hours, employee movements may follow different patterns as employees navigate through back areas to avoid guest traffic or perform duties in different sections of the venue.

When an employee STA enters the venue through the secondary entrance, the employee STA can initially associate to AP5, thereby establishing a connection between the employee STA and AP5. When the employee STA determines to roam or that roaming will occur soon, the employee STA requests a roaming recommendation from AP5 through zero-scan roaming processes (or existing roaming processes such as an 802.11v BTM query or 802.11k neighbor request). Based on the second type expected path 305, the time period, the expected load of the APs, and other information in the roaming map, AP5 can recommend one or more APs to roam to depending on the direction of travel and the employee STA’s likely destination.

The system uses the differentiated roaming map to provide a recommendation that matches the STA type and the current time value. For example, employee teams arriving at night for an inventory task can be guided through employees’ shortcuts to the store area that is their destination, while guests entering the facility during daytime do not receive roaming recommendations that match a shortcut. This differentiation ensures that employees receive efficient routing through staff-accessible areas while guests are directed along appropriate public pathways.

While FIG. 2 and FIG. 3 illustrate differentiation between guest STAs and employee STAs, the system can maintain differentiated maps for numerous STA types to provide highly customized roaming recommendations. For example, in a multi-floor venue such as an office building or hospital, separate maps can be built for employees that work primarily on different floors, with each map reflecting the typical movement patterns and frequently accessed areas for employees assigned to specific floors. In a shopping mall or entertainment venue, different employee roles can have distinct maps: food service employees may have paths that frequently traverse kitchen areas and service corridors; maintenance staff may have paths that include utility rooms, equipment areas, and building infrastructure locations; security personnel may have paths that cover perimeter areas, monitoring STAs, and emergency access points; and retail floor staff may have paths concentrated in sales areas and stockrooms.

Guest STAs can also be further differentiated into multiple types. For example, priority guests, VIP guests, or members with special access privileges may have maps that include premium areas, exclusive lounges, or expedited pathways not available to standard guests. Contractor or vendor STAs may have maps limited to specific work areas, loading docks, or service zones. Management or executive STAs may have maps that include administrative areas, conference rooms, and executive facilities. In healthcare settings, medical personnel STAs may have maps optimized for rapid access to patient care areas, operating rooms, and emergency facilities, while visitor STAs would have maps limited to public areas, waiting rooms, and designated visitation zones.

Each STA type can be identified through authentication credentials, network access policies, device profiles, user roles assigned in the network management system, or other identifying information, enabling the system to automatically select and apply the appropriate differentiated map when providing roaming recommendations. This multi-type differentiation approach ensures that each category of STA receives roaming recommendations optimized for their specific role, access privileges, and typical movement patterns within the venue.

Similar to the guest map described in FIG. 2, the employee roaming map includes elements such as the next best AP in any direction, the traversal time of the AP BSS, and the distance or times between BSSs for employee movement patterns. The roaming map for employee STAs may also include enhanced recommendations with temporal or distance elements, load balancing based on the sliding window mechanism, and integration with AP-to-AP communication and RRM engines as described with respect to FIG. 1 and FIG. 2.

By maintaining separate differentiated maps for employees and guests, and potentially for many other STA types, the system enables more accurate and efficient roaming recommendations tailored to the specific usage patterns, access privileges, and movement characteristics of each STA type.

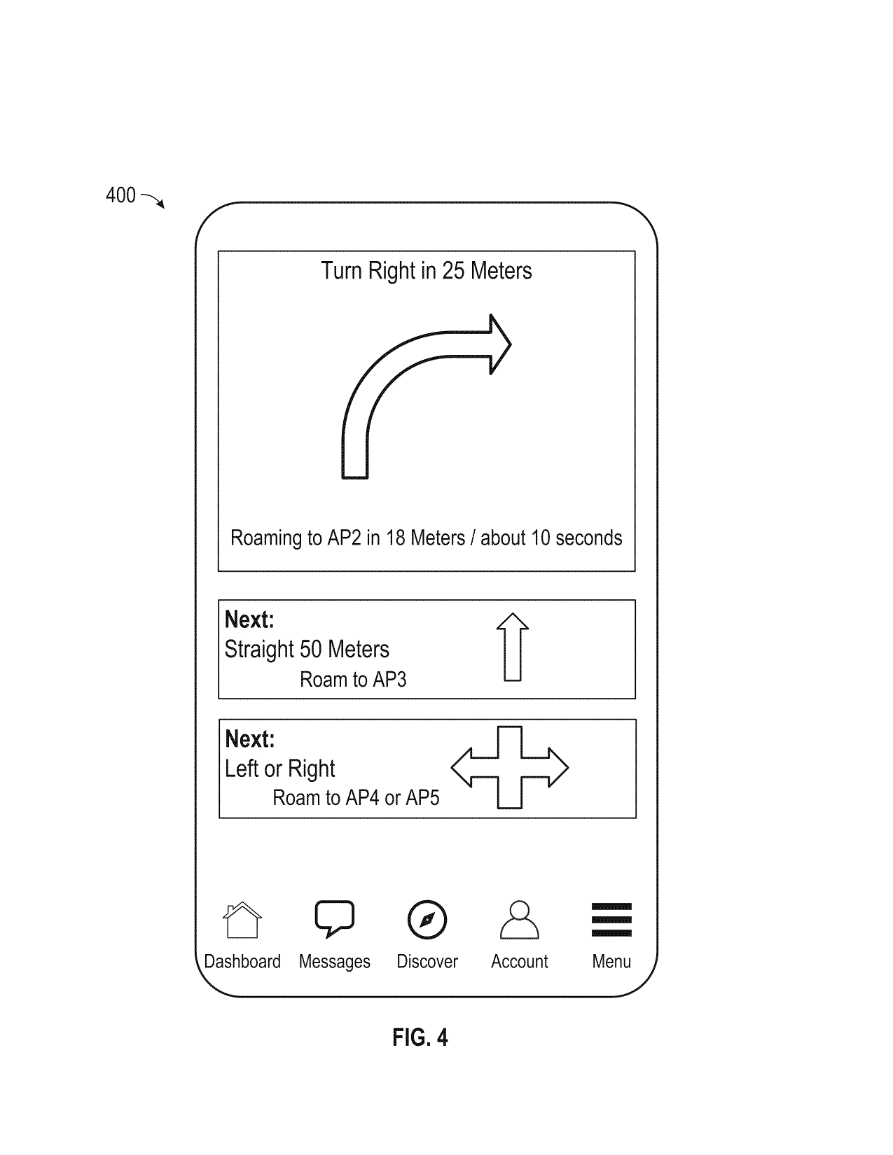

FIG. 4 illustrates an example user interface 400 providing turn-by-turn roaming recommendations to a STA. The user interface 400 displays navigation guidance integrated with roaming information, enabling the user to understand both where to move within the venue and when roaming events will occur. The turn-by-turn recommendations can be based on the expected path of the STA according to the differentiated map for the STA’s type, an input destination provided by the user, a determination of where to go for the best network connection, or a combination of these factors.

The user interface 400 includes a first recommendation 410 instructing the user to turn right in 25 meters. The first recommendation 410 also indicates that roaming to AP2 will occur in 18 meters, which corresponds to approximately 10 seconds of travel time at typical walking speed. This recommendation illustrates the temporal and distance elements that can be included in roaming recommendations. The recommendation “roam to AP2 in 18 meters” or “roam to AP2 in about 10 seconds” provides the STA and the user with additional information to anticipate the roaming event. This additional information can be used by the STA itself, equipped with measurement apparatus such as gyroscopes or clocks, to anticipate the time at which the next AP should be scanned and discovered. By surfacing this information to the user through the user interface 400, the user can understand that a seamless handoff will occur as they follow the recommended path.

The user interface 400 also includes a second recommendation 420 to be performed after the right turn indicated in the first recommendation 410 is completed. The second recommendation 420 instructs the user to travel straight for 50 meters. The second recommendation 420 also indicates that roaming to AP3 will occur during this segment of travel. Similar to the first recommendation 410, the second recommendation 420 can include temporal or distance information indicating when the roaming to AP3 will occur relative to the user’s current position or travel time.

The user interface 400 further includes a third recommendation 430 to be completed after traveling straight as indicated in the second recommendation 420. The third recommendation 430 presents the user with a choice to take a left or a right turn. The third recommendation 430 indicates that roaming to AP4 will occur if taking a left, while roaming to AP5 will occur if taking a right. This bifurcation in the recommendations can be based on different destinations the user may select, different expected paths in the differentiated map, or different optimal roaming targets based on current AP load conditions. For example, if the load balancing mechanism determines that AP4 has lower density than AP5, the system may prioritize recommending the left path to direct the user toward AP4. Alternatively, the user may have input a destination that is accessible via either path, and the system presents both options with the corresponding roaming information.

The turn-by-turn recommendations provided through the user interface 400 are particularly suitable for certain STA types where walking paths are well known and predictable. For example, guests traversing public areas of a venue do not cross walls or barriers, making their paths predictable and amenable to turn-by-turn guidance. The differentiated map for guest STAs, as illustrated in FIG. 2, provides the expected path information that enables the system to generate accurate turn-by-turn recommendations like those shown in the user interface 400.

In some embodiments, the recommendations provided through the user interface 400 are dynamically updated based on the STA’s actual movement, changes in AP load conditions, or changes to the user’s destination. For example, if the user deviates from the recommended path or if the sliding window mechanism determines that a different AP should be recommended for load balancing purposes, the user interface 400 can be updated to provide revised recommendations.

The user interface 400 enables users to benefit from the differentiated roaming maps and enhanced roaming recommendations by providing clear, actionable guidance that integrates navigation and network connectivity information. This approach improves the user experience by ensuring seamless roaming while also assisting users in navigating through the venue efficiently.

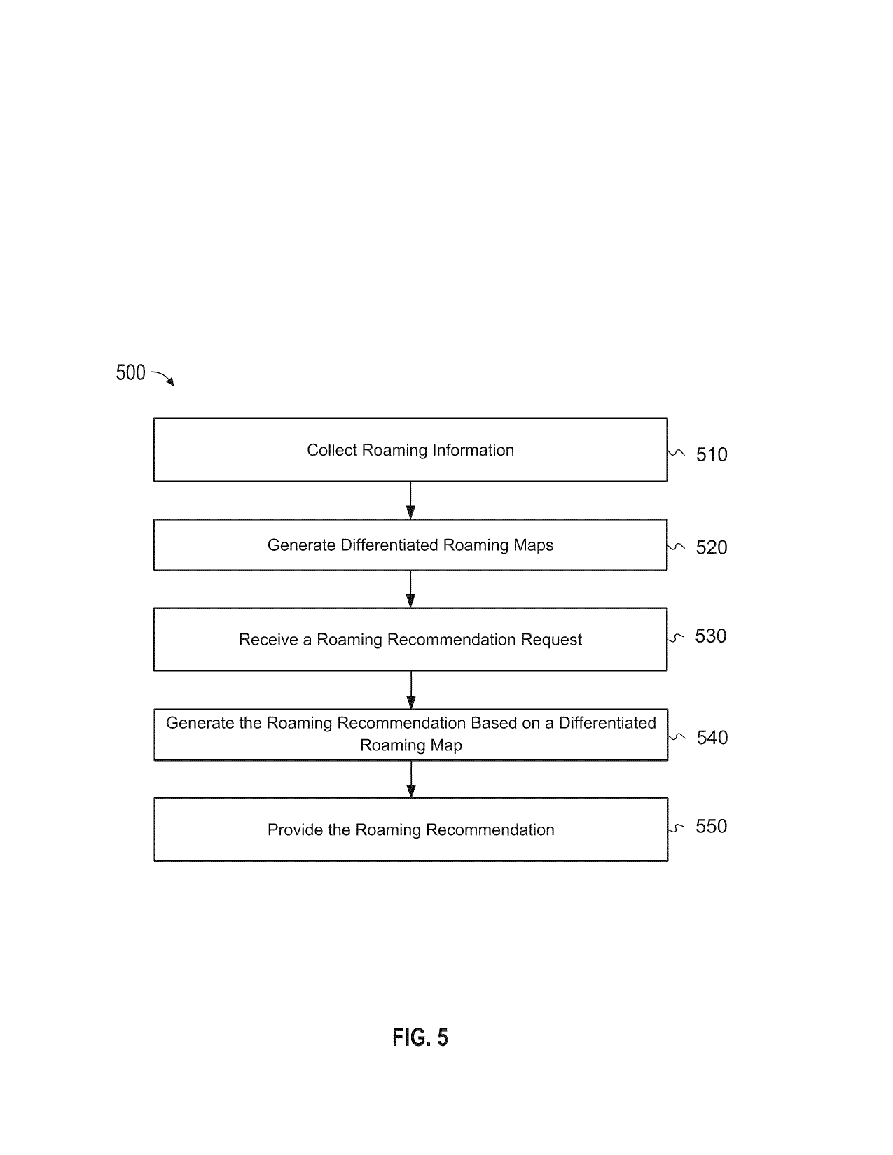

FIG. 5 is a flow diagram illustrating a method 500 for roaming using differentiated maps. The method 500 can be performed by one or more network devices, such as the first AP 102, the second AP 104, the third AP 106, the fourth AP 108, the controller 120, and/or the remote system 130 of FIG. 1, or any combination thereof.

At operation 510, one or more APs collect roaming information associated with a plurality of STAs in a wireless network. The roaming information includes STA requests for roaming recommendations, AP responses to the STA requests, roaming events indicating transitions of STAs between APs, and type information identifying a type associated with each STA of the plurality of STAs. For example, STAs associate to APs according to standard processes and request roaming recommendations from the APs through zero-scan roaming processes (or existing roaming processes like 802.11v BTM queries or 802.11k neighbor requests). The APs record the history of these STA requests, the AP responses, and the roaming events.

In some embodiments, the roaming information further includes movement data indicating at least one of: time before roaming events, dwell time at APs, traversal time between APs, or distances between roaming events. The system records additional information available related to STA movement, such as the time before the next roaming event, the dwell time on the next access point, or the distance between these different events.

The type information can identify various station types, such as employee devices versus guest devices, devices assigned to specific floors or areas, devices associated with specific roles (e.g., food service, maintenance, security, management), priority or VIP guests, contractors, or other classifications. The station type may be determined based on authentication credentials, network access policies, device profiles, time of day, or other identifying information.

At operation 520, the one or more network devices generate a plurality of differentiated roaming maps based on the roaming information. Each differentiated roaming map of the plurality of differentiated roaming maps corresponds to a respective type and indicates roaming patterns for STAs associated with that respective type. The APs or an associated mapping system use the collected information to build a local roaming map for each AP. The station type is recorded and differentiated maps are built accordingly. For example, in a shopping mall, a public roaming map is built from the roaming events of guests, while a staff map is built from the roaming events of employees.

In some embodiments, generating the plurality of differentiated roaming maps comprises generating, for the plurality of differentiated roaming maps, a vector map indicating, for each AP in the wireless network: directional information identifying neighboring APs in different directions from that AP, traversal times for STAs to traverse coverage areas of APs, and distances or times between BSSs of neighboring APs. For each AP, the map indicates elements such as the next best AP in any direction, the traversal time of the AP BSS, and/or the distance or times between BSSs.

The plurality of differentiated roaming maps may include temporal information indicating time intervals when roaming patterns are active for different station types. For example, guests are not expected at night while employee movements are expected. The maps can vary based on the time of day, with certain paths being active during specific hours.

At operation 530, a first AP receives a roaming recommendation request from a first STA. The roaming recommendation request may be an 802.11v BTM query, an 802.11k neighbor request, or another type of roaming recommendation request. The first STA may send the request when determining to roam or that roaming will occur soon, such as when certain transition conditions are met (e.g., signal degradation, load balancing triggers, or motion detection).

At operation 540, the one or more network devices determine a roaming recommendation indicating a second AP for the first STA to roam to based on a first differentiated roaming map from the plurality of differentiated roaming maps corresponding to a type of the first STA. Determining the roaming recommendation includes determining the type of the first STA (e.g., based on authentication credentials, network access policies, or device profiles) and selecting the first differentiated roaming map from the plurality of differentiated roaming maps based on the type of the first STA. The system uses the differentiated map to provide a recommendation that matches the station type and the current time value. For example, employee teams arriving at night for an inventory task can be guided through employees’ shortcuts to the store area that is their destination, while guests entering the facility during daytime do not receive roaming recommendations that match a shortcut.

In some embodiments, the method 500 includes maintaining a counter for tracking a number of STAs that requested roaming recommendations, identities of APs that were recommended to the STAs, and roaming decisions made by the STAs. For example, the first AP maintains a counter mapped to a sliding window that records different elements: the number of stations that requested a recommendation in the last time interval; the number and identity of the APs that were recommended to these stations; and the roaming decision that each of these stations made. The method 500 further includes determining a load balancing weight for a plurality of candidate APs based on the counter and selecting the second AP from the plurality of candidate APs based on the load balancing weight. Upon receiving a new station request, the AP examines these elements and uses them as weights to provide a better, targeted response to the STA.

In some embodiments, determining the roaming recommendation comprises communicating with a plurality of candidate APs to measure current load on each candidate AP of the plurality of candidate APs, and selecting the second AP based on the current load on each candidate AP of the plurality of candidate APs. AP-to-AP communication allows the AP to measure the load on candidate APs and adapt its recommendations accordingly. In some embodiments, the roaming recommendations are connected to an RRM engine, causing the AP to suggest one or more APs to reduce power and one or more other APs to increase power to load balance the roaming events. This input is fed into the RRM engine, which uses this information as a parameter in its power balancing decisions.

In some embodiments, the roaming recommendation includes at least one of a temporal element or a distance element indicating when or where the first STA should roam to the second AP. The temporal element or the distance element comprises at least one of a time duration until roaming or a distance until roaming. For example, the recommendation includes temporal or distance elements such as “roam to AP2 in 18 meters” or “roam to AP2 in about 10 seconds.” This additional information can be used by the STA itself, equipped with measurement apparatus such as a gyroscope or clock, to anticipate the time at which the next AP should be scanned and discovered.

At operation 550, the first AP provides the roaming recommendation to the first STA. In some embodiments, providing the roaming recommendation includes selecting the second AP based on both the first differentiated roaming map and a current time value. The roaming recommendation enables the first STA to perform zero-scan roaming by transitioning to the second AP without performing a full channel scan. In some embodiments, the roaming recommendation is provided as part of a turn-by-turn navigation recommendation that guides the user of the first STA through the venue. This additional information can be surfaced to the user through a user interface on the first STA.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for roaming using differentiated roaming maps. Computing device 600, for example, may provide an operating environment for the first AP 102, the second AP 104, the third AP 106, the fourth AP 108, the STA 110, the controller 120, the remote system 130, and the like. The first AP 102, the second AP 104, the third AP 106, the fourth AP 108, the STA 110, the controller 120, the remote system 130, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 600 on the single integrated circuit (chip).

FIG. 7 illustrates an implementation of a communications device 700 that may implement one or more of the first AP 102, the second AP 104, the third AP 106, the fourth AP 108, the STA 110, the controller 120, the remote system 130, etc. In various implementations, the communications device 700 may comprise a logic circuit. The logic circuit may include physical circuits to perform operations described for one or more of the first AP 102, the second AP 104, the third AP 106, the fourth AP 108, the STA 110, the controller 120, the remote system 130, etc., for example. As shown in FIG. 7, the communications device 700 may include one or more of, but is not limited to, a radio interface 710, baseband circuitry 730, and/or the computing device 600.

The communications device 700 may implement some or all of the structures and/or operations for the first AP 102, the second AP 104, the third AP 106, the fourth AP 108, the STA 110, the controller 120, the remote system 130, etc., storage medium, and logic circuit in a single computing entity, such as entirely within a single device. Alternatively, the communications device 700 may distribute portions of the structure and/or operations using a distributed system architecture, such as a client STA server architecture, a peer-to-peer architecture, a primary-secondary architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHY layer processing circuit for the PHY link layer processing of respective receive/transmit signals. Baseband circuitry 730 may include, for example, a MAC processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
collecting, by one or more access points (APs), roaming information associated with a plurality of stations (STAs) in a wireless network, the roaming information including STA requests for roaming recommendations, access point (AP) responses to the STA requests, roaming events indicating transitions of STAs between APs, and type information identifying a type associated with each STA of the plurality of STAs;
generating a plurality of differentiated roaming maps based on the roaming information, wherein each differentiated roaming map of the plurality of differentiated roaming maps corresponds to a respective type and indicates roaming patterns for STAs associated with that respective type;
receiving, by a first AP, a roaming recommendation request from a first STA;
determining a roaming recommendation indicating a second AP for the first STA to roam to based on a first differentiated roaming map from the plurality of differentiated roaming maps corresponding to a type of the first STA; and
providing, by the first AP, the roaming recommendation to the first STA.

2. The method of claim 1, wherein:
the roaming information further includes movement data indicating at least one of: time before roaming events, dwell time at APs, traversal time between APs, or distances between roaming events.

3. The method of claim 1, further comprising:
tracking a number of STAs that requested roaming recommendations, identities of APs that were recommended to the STAs, and roaming decisions made by the STAs;
determining a load balancing weight for a plurality of candidate APs based on the number of STAs that requested roaming recommendations, the identities of APs that were recommended to the STAs, and the roaming decisions made by the STAs; and
selecting the second AP from the plurality of candidate APs based on the load balancing weight.

4. The method of claim 1, wherein:
the roaming recommendation includes at least one of a temporal element or a distance element indicating when or where the first STA should roam to the second AP, and
the temporal element or the distance element comprises at least one of a time duration until roaming or a distance until roaming.

5. The method of claim 1, wherein generating the plurality of differentiated roaming maps comprises:
generating, for the plurality of differentiated roaming maps, a vector map indicating, for each AP in the wireless network: directional information identifying neighboring APs in different directions from that AP, traversal times for STAs to traverse coverage areas of APs, and distances or times between Basic Service Sets (BSSs) of neighboring APs.

6. The method of claim 1, wherein:
the plurality of differentiated roaming maps include temporal information indicating time intervals when roaming patterns are active for different station types; and
providing the roaming recommendation to the first STA comprises selecting the second AP based on both the first differentiated roaming map and a current time value.

7. The method of claim 1, wherein determining the roaming recommendation comprises:
communicating, by the first AP, with a plurality of candidate APs to measure a current load on each candidate AP of the plurality of candidate APs; and
selecting the second AP based on the current load on each candidate AP of the plurality of candidate APs.

8. A system comprising:
a processing unit; and
a memory storage storing instructions that, when executed by the processing unit, cause the system to:
collect roaming information associated with a plurality of stations (STAs) in a wireless network, the roaming information including STA requests for roaming recommendations, access point (AP) responses to the STA requests, roaming events indicating transitions of STAs between APs, and type information identifying a type associated with each STA of the plurality of STAs;
generate a plurality of differentiated roaming maps based on the roaming information, wherein each differentiated roaming map of the plurality of differentiated roaming maps corresponds to a respective type and indicates roaming patterns for STAs associated with that respective type;
receive a roaming recommendation request from a first STA;
determine a roaming recommendation indicating a second AP for the first STA to roam to based on a first differentiated roaming map from the plurality of differentiated roaming maps corresponding to a type of the first STA; and
provide the roaming recommendation to the first STA.

9. The system of claim 8, wherein:
the roaming information further includes movement data indicating at least one of: time before roaming events, dwell time at APs, traversal time between APs, or distances between roaming events.

10. The system of claim 8, wherein the instructions, when executed by the processing unit, further cause the system to:
track a number of STAs that requested roaming recommendations, identities of APs that were recommended to the STAs, and roaming decisions made by the STAs;
determine a load balancing weight for a plurality of candidate APs based on the number of STAs that requested roaming recommendations, the identities of APs that were recommended to the STAs, and the roaming decisions made by the STAs; and
select the second AP from the plurality of candidate APs based on the load balancing weight.

11. The system of claim 8, wherein:
the roaming recommendation includes at least one of a temporal element or a distance element indicating when or where the first STA should roam to the second AP, and
the temporal element or the distance element comprises at least one of a time duration until roaming or a distance until roaming.

12. The system of claim 8, wherein the instructions to generate the plurality of differentiated roaming maps, when executed by the processing unit, cause the system to:
generate, for the plurality of differentiated roaming maps, a vector map indicating, for each AP in the wireless network: directional information identifying neighboring APs in different directions from that AP, traversal times for STAs to traverse coverage areas of APs, and distances or times between Basic Service Sets (BSSs) of neighboring APs.

13. The system of claim 8, wherein:
the plurality of differentiated roaming maps include temporal information indicating time intervals when roaming patterns are active for different station types; and
the instructions to provide the roaming recommendation to the first STA, when executed by the processing unit, cause the system to select the second AP based on both the first differentiated roaming map and a current time value.

14. The system of claim 8, wherein the instructions to determine the roaming recommendation, when executed by the processing unit, cause the system to:
communicate with a plurality of candidate APs to measure a current load on each candidate AP of the plurality of candidate APs; and
select the second AP based on the current load on each candidate AP of the plurality of candidate APs.

15. A non-transitory computer-readable medium storing instructions that, when executed by one or more processors, cause the one or more processors to perform a method comprising:
collecting roaming information associated with a plurality of stations (STAs) in a wireless network, the roaming information including STA requests for roaming recommendations, access point (AP) responses to the STA requests, roaming events indicating transitions of STAs between APs, and type information identifying a type associated with each STA of the plurality of STAs;
generating a plurality of differentiated roaming maps based on the roaming information, wherein each differentiated roaming map of the plurality of differentiated roaming maps corresponds to a respective type and indicates roaming patterns for STAs associated with that respective type;
receiving a roaming recommendation request from a first STA;
determining a roaming recommendation indicating a second AP for the first STA to roam to based on a first differentiated roaming map from the plurality of differentiated roaming maps corresponding to a type of the first STA; and
providing the roaming recommendation to the first STA.

16. The non-transitory computer-readable medium of claim 15, wherein:
the roaming information further includes movement data indicating at least one of: time before roaming events, dwell time at APs, traversal time between APs, or distances between roaming events.

17. The non-transitory computer-readable medium of claim 15, wherein the method further comprises:
tracking a number of STAs that requested roaming recommendations, identities of APs that were recommended to the STAs, and roaming decisions made by the STAs;
determining a load balancing weight for a plurality of candidate APs based on the number of STAs that requested roaming recommendations, the identities of APs that were recommended to the STAs, and the roaming decisions made by the STAs; and
selecting the second AP from the plurality of candidate APs based on the load balancing weight.

18. The non-transitory computer-readable medium of claim 15, wherein:
the roaming recommendation includes at least one of a temporal element or a distance element indicating when or where the first STA should roam to the second AP, and
the temporal element or the distance element comprises at least one of a time duration until roaming or a distance until roaming.

19. The non-transitory computer-readable medium of claim 15, wherein generating the plurality of differentiated roaming maps comprises:
generating, for the plurality of differentiated roaming maps, a vector map indicating, for each AP in the wireless network: directional information identifying neighboring APs in different directions from that AP, traversal times for STAs to traverse coverage areas of APs, and distances or times between Basic Service Sets (BSSs) of neighboring APs.

20. The non-transitory computer-readable medium of claim 15, wherein:
the plurality of differentiated roaming maps include temporal information indicating time intervals when roaming patterns are active for different station types; and
providing the roaming recommendation to the first STA comprises selecting the second AP based on both the first differentiated roaming map and a current time value.
